(19) United States
(12) Patent Application Publication
(10) Pub. No.: US 2018/0131633 A1
(43) Pub. Date: May 10, 2018

(54) CAPACITY MANAGEMENT OF CABINET-SCALE RESOURCE POOLS

(71) Applicant: Alibaba Group Holding Limited, George Town (KY)

(72) Inventor: Shu Li, Bothell, WA (US)

(21) Appl. No.: 15/345,997

(22) Filed: Nov. 8, 2016

(51) Int. Cl. H04L 12/911; H04L 12/24

(52) U.S. Cl. CPC H04L 47/821; H04L 41/0813

(57) ABSTRACT

Capacity management includes: determining that a first set of one or more services configured to execute on a set of one or more existing virtual nodes requires additional hardware resources; releasing a set of one or more hardware resources from a second set of one or more services; grouping at least some of the released set of one or more hardware resources into a set of one or more newly grouped virtual nodes; and providing hardware resources to the first set of one or more services using at least the set of one or more newly grouped virtual nodes.

### BACKGROUND OF THE INVENTION

In traditional data centers, servers are deployed to run multiple applications (also referred to as services). These applications/services often consume resources such as computation, networking, storage, etc. with different characteristics. Further, at different moments in time, the capacity utilization of certain services can change significantly. To avoid capacity shortage at peak times, the conventional infrastructure design is based on peak usage. In other words, the system is designed to have as many resources as the peak requirements. This is referred to as maximum design of infrastructure.

In practice, maximum design of infrastructure usually leads to inefficient utilization of resources and high total cost of ownership (TCO). For example, an e-commerce company may operate a data center that experiences high workloads a few times a year (e.g., during holidays and sales events). If the number of servers is deployed to match the peak usage, many of these servers will be idle the rest of the time. In an environment where new services are frequently deployed, the cost problem is exacerbated.

Further, many hyperscale data centers today face practical issues such as cabinet space, cabinet power budget, thermal dissipation, construction code, etc. Deploying data center infrastructure efficiently and with sufficient capacity has become crucial to data center operators.

### SUMMARY

The present application discloses a method of capacity management, comprising: determining that a first set of one or more services configured to execute on a set of one or more existing virtual nodes requires additional hardware resources; releasing a set of hardware resources from serving a second set of services; grouping at least some of the released set of hardware resources into a set of newly grouped virtual nodes; and providing hardware resources to the first set of services using at least the set of newly grouped virtual nodes.

In some embodiments, a virtual node among the set of one or more existing virtual nodes includes a plurality of storage resources; and the plurality of storage resources are included in a cabinet-scale storage system that provides storage resources but does not provide compute resources.

In some embodiments, a virtual node among the set of one or more existing virtual nodes includes a plurality of compute resources; and the plurality of compute resources are included in a cabinet-scale compute system that provides compute resources but does not provide storage resources.

In some embodiments, the released set of one or more hardware resources includes a storage element, a processor, or both.

In some embodiments, the first set of one or more services has higher priority than the second set of one or more services.

In some embodiments, the first set of one or more services includes one or more of: a database service, a load balance service, a diagnostic service, a high performance computation service, and/or a storage service.

In some embodiments, the second set of one or more services includes one or more of: a content delivery network service, a data processing service, and/or a cache service.

In some embodiments, the providing of hardware resources to the first set of one or more services using at least the set of one or more newly grouped virtual nodes includes assigning a request associated with the first set of one or more services to at least some of the set of one or more newly grouped virtual nodes.

In some embodiments, at least one of the set of one or more existing virtual nodes is configured as a main node having an original backup node; and the providing of hardware resources to the first set of one or more services using at least the set of one or more newly grouped virtual nodes includes: configuring a first virtual node among the set of one or more newly grouped virtual nodes as a new backup node for the main node, and a second virtual node among the set of one or more newly grouped virtual nodes as a backup node for the original backup node of the main node; and promoting the original backup node of the main node to be a second main node.

The present application also describes a capacity management system, comprising: one or more processors configured to: determine that a first set of one or more services configured to execute on a set of one or more existing virtual nodes requires additional hardware resources; release a set of one or more hardware resources from a second set of one or more services; group at least some of the released set of one or more hardware resources into a set of one or more newly grouped virtual nodes; and provide hardware resources to the first set of one or more services using at least the set of one or more newly grouped virtual nodes. The capacity management system further includes one or more memories coupled to the one or more processors, configured to provide the one or more processors with instructions.

In some embodiments, a virtual node among the set of one or more existing virtual nodes includes a plurality of storage resources; and the plurality of storage resources are included in a cabinet-scale storage system.

In some embodiments, a virtual node among the set of one or more existing virtual nodes includes a plurality of storage resources; and the plurality of storage resources are included in a cabinet-scale storage system; wherein the cabinet-scale storage system includes: one or more top of rack (TOR) switches; and a plurality of storage devices coupled to the one or more TORs; wherein the one or more TORs switch storage-related traffic and do not switch compute-related traffic.

In some embodiments, a virtual node among the set of one or more existing virtual nodes includes a plurality of compute resources; and the plurality of compute resources are included in a cabinet-scale compute system.

In some embodiments, a virtual node among the set of one or more existing virtual nodes includes a plurality of compute resources; the plurality of compute resources are included in a cabinet-scale compute system; and the cabinet-scale compute system includes: one or more top of rack (TOR) switches; and plurality of compute devices coupled to the one or more TORs; wherein the one or more TORs switch compute-related traffic and do not switch storage-related traffic.

In some embodiments, the released set of one or more hardware resources includes a storage element, a processor, or both.

In some embodiments, the first set of one or more services has higher priority than the second set of one or more services.

In some embodiments, the first set of one or more services includes one or more of: a database service, a load balance service, a diagnostic service, a high performance computation service, and/or a storage service.

In some embodiments, the second set of one or more services includes one or more of: a content delivery network service, a data processing service, and/or a cache service.

In some embodiments, to provide hardware resources to the first set of one or more services using at least the set of one or more newly grouped virtual nodes includes to assign a request associated with the first set of one or more services to at least some of the set of one or more newly grouped virtual nodes.

In some embodiments, at least one of the set of one or more existing virtual nodes is configured as a main node having an original backup node; and to provide hardware resources to the first set of one or more services using at least the set of one or more newly grouped virtual nodes includes to: configure a first virtual node among the set of one or more newly grouped virtual nodes as a new backup node for the main node, and a second virtual node among the set of one or more newly grouped virtual nodes as a backup node for the original backup node of the main node; and promote the original backup node of the main node to be a second main node.

The application further discloses a computer program product for capacity management, the computer program product being embodied in a tangible non-transitory computer readable storage medium and comprising computer instructions for: determining that a first set of one or more services configured to execute on a set of one or more existing virtual nodes requires additional hardware resources; releasing a set of hardware resources from serving a second set of services; grouping at least some of the released set of one or more hardware resources into a set of one or more newly grouped virtual nodes; and providing hardware resources to the first set of one or more services using at least the set of one or more newly grouped virtual nodes.

The application further discloses a cabinet-scale system, comprising: one or more top of rack switches (TORs); and a plurality of devices coupled to the one or more TORs, configured to provide hardware resources to one or more services; wherein: the plurality of devices includes a plurality of storage devices or a plurality of compute devices; in the event that the plurality of devices includes the plurality of storage devices, the one or more TORs are configured to switch storage-related traffic and not to switch compute-related traffic; and in the event that the plurality of devices includes the plurality of compute devices, the one or more TORs are configured to switch compute-related traffic and not to switch storage-related traffic.

In some embodiments, the one or more TORs include at least two TORs in high availability (HA) configuration.

In some embodiments, the one or more TORs are to switch only storage-related traffic; and a storage device included in the plurality of devices includes: one or more network interface cards (NICs) coupled to the one or more TORs; a plurality of high latency drives coupled to the one or more NICs; and a plurality of low latency drives coupled to the one or more NICs.

In some embodiments, the one or more TORs are configured to switch only storage-related traffic; and a storage device included in the plurality of devices includes: one or more network interface cards (NICs) coupled to the one or more TORs; and a plurality of drives coupled to the one or more NICs.

In some embodiments, the one or more TORs are configured to switch only storage-related traffic; and a storage device included in the plurality of devices includes: a remote direct memory access (RDMA) network interface card (NIC); a host bus adaptor (HBA); a peripheral component interconnect express (PCIe) switch; a plurality of hard disk drives (HDDs) coupled to the NIC via the HBA; and a plurality of solid state drives (SSDs) coupled to the NIC via the PCIe switch.

In some embodiments, the plurality of SSDs are exposed to external devices as Ethernet drives.

In some embodiments, the RDMA NIC is one of a plurality of RDMA NICs configured in HA configuration; the HBA is one of a plurality of HBAs configured in HA configuration; and the PCIe switch is one of a plurality of PCIe switches configured in HA configuration.

In some embodiments, the one or more TORs are configured to switch only compute-related traffic; and a compute device included in the plurality of devices includes: a network interface card (NIC) coupled to the one or more TORs; and a plurality of processors coupled to the network interface card.

In some embodiments, the plurality of processors includes one or more central processing units (CPUs) and one or more graphical processing units (GPUs).

In some embodiments, the compute device further includes a plurality of memories configured to provide the plurality of processors with instructions, wherein the plurality of memories includes a byte-addressable non-volatile memory configured to provide operating system boot code.

### BRIEF DESCRIPTION OF THE DRAWINGS

Various embodiments of the invention are disclosed in the following detailed description and the accompanying drawings.

FIG. 1 is a block diagram illustrating an embodiment of a capacity managed data center and its logical components.

FIG. 2 is a block diagram illustrating an embodiment of a capacity managed data center and its physical components.

FIG. 3 is a block diagram illustrating an example of a server cluster with several single-resource cabinets.

FIG. 4 is a block diagram illustrating an embodiment of a storage box.

FIG. 5 is a block diagram illustrating embodiments of a compute box.

FIG. 6 is a flowchart illustrating an embodiment of a process for performing capacity management.

FIG. 7 is a block diagram illustrating the borrowing of resources from low priority services to meet the demands of a high priority service.

FIG. 8 is a block diagram illustrating an embodiment of a capacity managed system in high availability configuration.

FIG. 9A is a block diagram illustrating an embodiment of a high availability configuration.

FIG. 9B is a block diagram illustrating an embodiment of a high availability configuration.

FIG. 9C is a block diagram illustrating an embodiment of a high availability configuration.

FIG. 10 is a flowchart illustrating an embodiment of a high availability configuration process.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Capacity management is disclosed. When additional hardware resources are needed by a first set of one or more services, a second set of one or more services releases a set of one or more hardware resources, and the released hardware resources are grouped into virtual nodes. Hardware resources are provided to the first set of one or more services using the virtual nodes. In some embodiments, cabinet-scale systems are used to provide the hardware resources, including cabinet-scale storage systems and cabinet-scale compute systems.

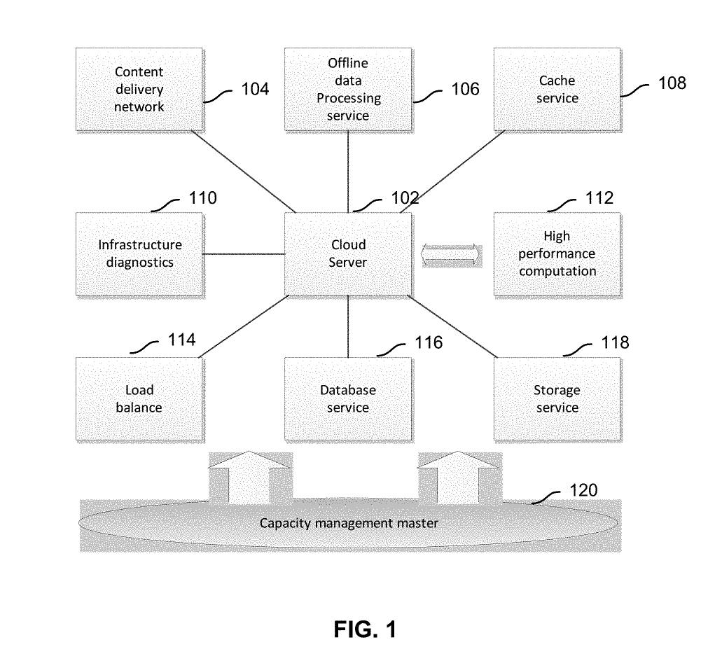

FIG. 1 is a block diagram illustrating an embodiment of a capacity managed data center and its logical components. The data center is implemented by cloud server 102, which operates multiple services, such as content delivery network (CDN) service 104, offline data processing service (ODPS) 106, cache service 108, high performance computation (HPC) 112, storage service 118, database service 116, etc. Certain services targeting the data center itself, such as infrastructure diagnostics service 110 and load balancing service 114, are also supported. Additional services and/or different combinations of services can be supported in other embodiments. A capacity management master (CMM) 120 monitors hardware resources (e.g., computation power and storage capacity) usage and manages available capacity among these services. Logical groupings of hardware resources, referred to as virtual nodes, are used to manage hardware resources. In this example, over time, the CMM dynamically groups hardware resources as virtual nodes, and provides the virtual nodes to the services. In other words, the CMM forms a bottom layer of service that manages hardware resources by configuring and distributing resources among the services.

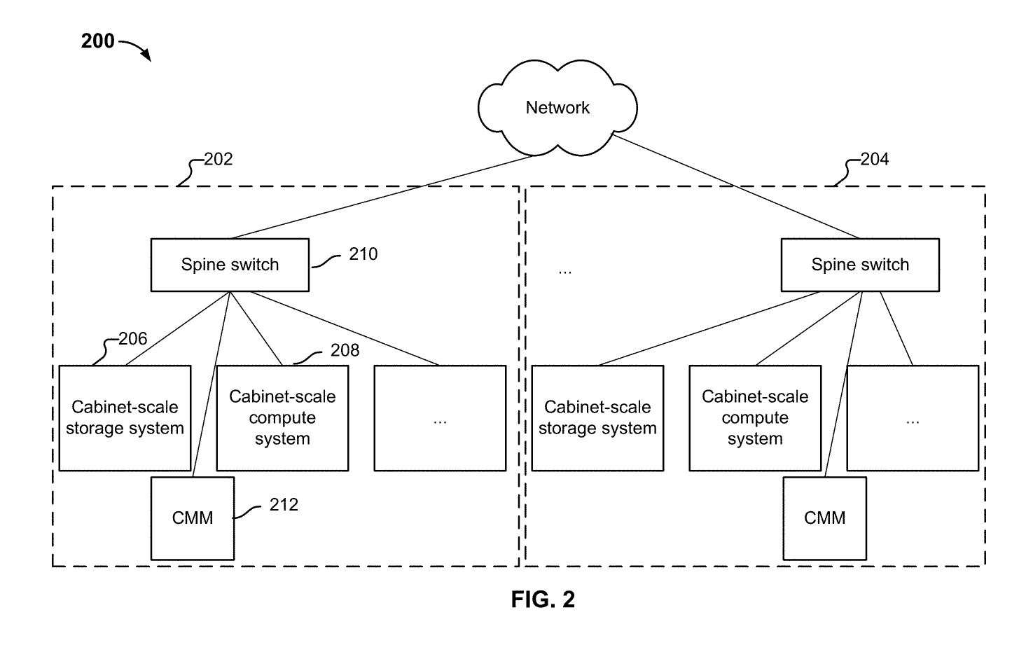

FIG. 2 is a block diagram illustrating an embodiment of a capacity managed data center and its physical components. The data center 200 includes server clusters such as 202, 204, etc. which includes multiple cabinet-scale systems such as 206, 208, etc., connected to the rest of the network via one or more spine switches such as 210. Other types of systems can be included in a server cluster as well. A cabinet-scale system refers to a system comprising a set of devices or appliances connected to a cabinet-scale switch (referred to as a top of rack switch (TOR)), providing a single kind of hardware resource (e.g., either compute power or storage capacity) to the services and handling a single kind of traffic associated with the services (e.g., either compute-related traffic or storage-related traffic). For example, a cabinet-scale storage system 206 includes storage appliances/devices configured to provide services with storage resources but does not include any compute appliances/devices. A compute-based single-resource cabinet 208 includes compute appliances/devices configured to provide services with compute resources but does not include any storage appliances/devices. A single-resource cabinet is optionally enclosed by a physical enclosure that fits within a standard rack space provided by a data center (e.g., a metal box measuring 45″×19″×24″). Although the TORs described herein are preferably placed at the top of the rack, they can also be placed in other locations of the cabinet as appropriate.

In this example, CMM 212 is implemented as software code installed on a separate server. In some embodiments, multiple CMMs are installed to provide high availability/failover protection. A Configuration Management Agent (CMA) is implemented as software code installed on individual appliances. The CMM maintains mappings of virtual nodes, services, and hardware resources. Through a predefined protocol (e.g., a custom TCP-based protocol that defines commands and their corresponding values), the CMM communicates with the CMAs and configures virtual nodes using different hardware resources from various single-resource cabinets. In particular, the CMM sends commands such as setting a specific configuration setting to a specific value, reading from or writing to a specific drive, performing certain computation on a specific central processing unit (CPU), etc. Upon receiving a command, the appropriate CMA will execute the command. The CMM's operations are described in greater detail below.

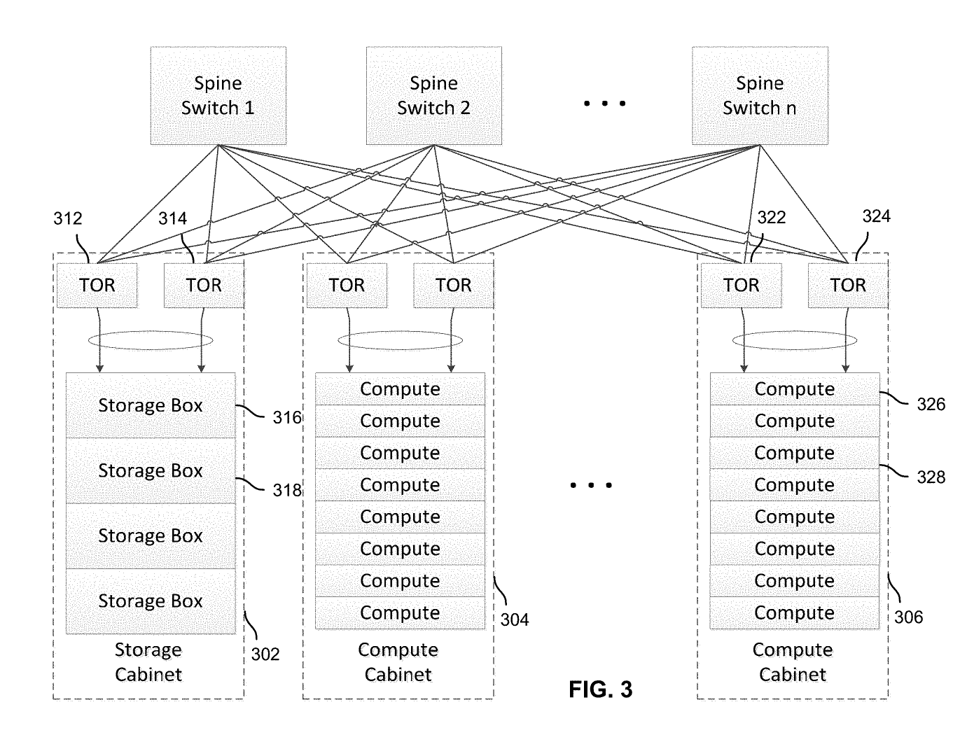

FIG. 3 is a block diagram illustrating an example of a server cluster with several single-resource cabinets. In this example, within storage cabinet 302, a pair of TORs are configured in a high availability (HA) configuration. Specifically, TOR 312 is configured as the main switch for the cabinet, and TOR 314 is configured as the standby switch. During normal operation, traffic is switched by TOR 312. TOR 314 can be synchronized with TOR 312. For example, TOR 314 can maintain the same state information (e.g., session information) associated with traffic as TOR 312. In the event that TOR 312 fails, traffic will be switched by TOR 314. In some embodiments, the TORs can be implemented using standard network switches and the bandwidth, number of ports, and other requirements of the switch can be selected based on system needs. In some embodiments, the HA configuration can be implemented according to a high availability protocol such as the High-availability Seamless Redundancy (HSR) protocol.

The TORs are connected to individual storage devices (also referred to as storage boxes) 316, 318, etc. Similarly, within compute cabinet 306, TOR 322 is configured as the main switch and TOR 324 is configured as the standby switch that provides redundancy to the main switch. TORs 322 and 324 are connected to individual compute boxes 326, 328, etc. The TORs are connected to spine switches 1-n, which connect the storage cluster to the rest of the network.

In this example, the TORs, their corresponding storage boxes or compute boxes, and spine switches are connected through physical cables between appropriate ports. Wireless connections can also be used as appropriate. The TORs illustrated herein are configurable. When the configuration settings for a TOR are tuned to suit the characteristics of the traffic being switched by the TOR, the TOR will achieve better performance (e.g., fewer dropped packets, greater throughput, etc.). For example, for distributed storage, there are often multiple copies of the same data to be sent to various storage elements, thus the downlink to the storage elements within the cabinet requires more bandwidth than the uplink from the spine switch. Since TOR 312 and its standby TOR 314 will only switch storage-related traffic (e.g., storage-related requests and data to be stored, responses to the storage-related requests, etc.), they can be configured to have a relatively high (e.g., greater than 1) downlink to uplink bandwidth ratio. In comparison, a lower downlink to uplink bandwidth ratio (e.g., less than or equal to 1) can be configured for TOR 322 and its standby TOR 324, which only switch compute-related traffic (e.g., compute-related requests, data to be computed, computation results, etc.). The separation of different kinds of resources for different purposes (in this case, storage resources and compute resources) into different cabinets allows the same kind of traffic to be switched by a TOR, thus enabling a more optimized configuration for the TOR.

Cabinet-scale systems such as 302, 304, 306, etc. are connected to each other and the rest of the network via spine switches 1-n. In the topology shown, each spine switch connects to all the TORs to provide redundancy and high throughput. The spine switches can be implemented using standard network switches.

In this example, the TORs are preferably implemented using access switches that can support both level 2 switching and level 3 switching. The data exchanges between a storage cabinet and a compute cabinet are carried out through the corresponding TORs and spine switch, using level 3 Ethernet packets (IP packets). The data exchanges within one cabinet are carried out by the TOR, using level 2 Ethernet packets (MAC packets). Using level 2 Ethernet is more efficient than using level 3 Ethernet since the level 2 Ethernet relies on MAC addresses rather than IP addresses.

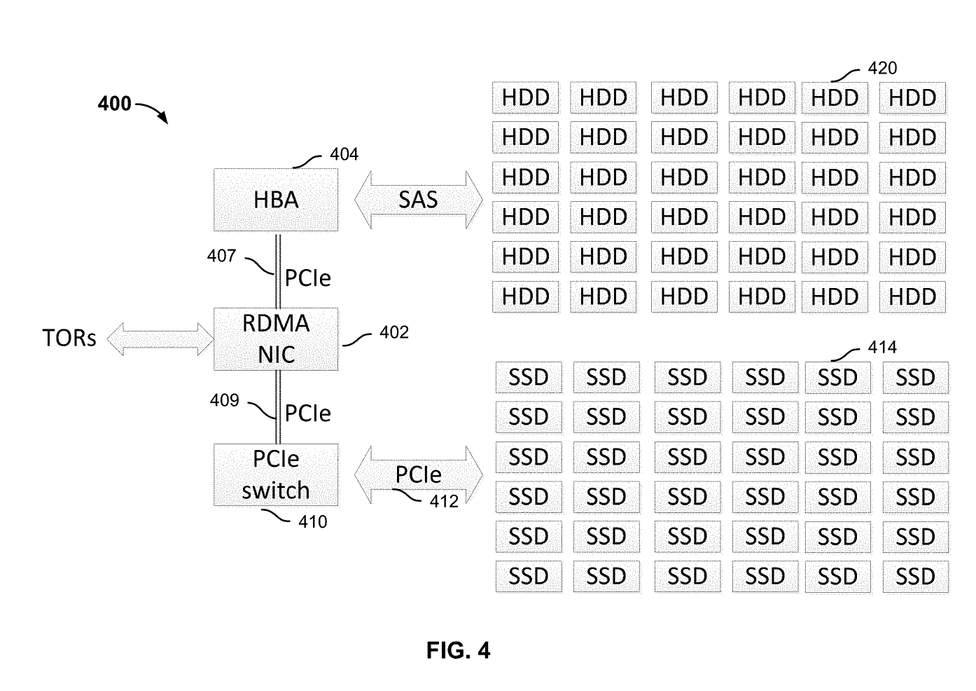

FIG. 4 is a block diagram illustrating an embodiment of a storage box. Storage box 400 includes storage elements and certain switching elements. In the example shown, a remote direct memory access (RDMA) network interface card (NIC) 402 is to be connected to a TOR (or a pair of TORs in a high availability configuration) via an Ethernet connection. RDMA NIC 402, which is located in a Peripheral Component Interconnect (PCI) slot within the storage cabinet, provides PCI express (PCIe) lanes. RDMA NIC 402 converts Ethernet protocol data it receives from the TOR to PCIe protocol data to be sent to Host Bus Adaptor (HBA) 404 or PCIe switch 410. It also converts PCIe data to Ethernet data in the opposite data flow direction.

A portion of the PCIe lanes (specifically, PCIe lanes 407) are connected to HBA 404, which serves as a Redundant Array of Independent Disks (RAID) card that provides hardware implemented RAID functions to prevent a single HDD failure from interrupting the services. HBA 404 converts PCIe lanes 407 into Serial Attached Small Computer System Interface (SAS) channels that connect to multiple HDDs 420. The number of HDDs is determined based on system requirements and can vary in different embodiments. Since each HDD requires one or more SAS channels and the number of HDDs can exceed the number of PCIe lanes 407 (e.g., PCIe lanes 407 has 16 lanes but there are 100 HDDs), HBA 404 can be configured to perform lane-channel extension using techniques such as time division multiplexing. The HDDs are mainly used as local drives of the storage box. The HDDs' capacity is exposed through a distributed storage system such as Hadoop Distributed File System (HDFS) and accessible using APIs supported by such a distributed storage system.

Another portion of the PCIe lanes (specifically, PCIe lanes 409) are further extended by PCIe switch 410 to provide additional PCIe lanes for SSDs 414. Since each SSD requires one or more PCIe lanes and the number of SSDs can exceed the number of lanes in PCIe lanes 409, the PCIe switch can use techniques such as time division multiplexing to extend a limited number of PCIe lanes 409 into a greater number of PCIe lanes 412 as needed to service the SSDs. In this example, RDMA NIC 402 supports RDMA over Converged Ethernet (RoCE) (v1 or v2), which allows remote direct memory access of the SSDs over Ethernet. Thus, an SSD is exposed to external devices as an Ethernet drive that is mapped as a remote drive of a host, and can be accessed through Ethernet using Ethernet API calls.

The HDDs and SDDs can be accessed directly through Ethernet by other servers for reading and writing data. In other words, the servers' CPUs do not have to perform additional processing on the data being accessed. RDMA NIC 402 maintains one or more mapping tables of files and their corresponding drives. For example, a file named “abc” is mapped to HDD 420, another file named “efg” is mapped to SSD 414, etc. In this case, the HDDs are identified using corresponding Logical Unit Numbers (LUNs) and the SSDs are identified using names in corresponding namespaces. The file naming and drive identification convention can vary in different embodiments. APIs are provided such that the drives are accessed as files. For example, when an API call is invoked on the TOR to read from or write to a file, a read operation from or a write operation to a corresponding drive will take place.

The HDDs generally have higher latency and less cost of ownership than the SSDs. Thus, the HDDs are used to provide large capacity storage which permits higher latency but requires moderate cost, and the SSDs are used to provide fast permanent storage and cache for reads and writes to the HDDs. The use of mixed storage element types allows flexible designs that achieve both performance and cost objectives. In various other embodiments, a single type of storage elements, different types of storage elements, and/or additional types of storage elements can be used.

Since the example storage box shown does not perform compute operations for services, storage box 400 requires no local CPU or DIMM. One or more microprocessors can be included in the switching elements such as RDMA NIC 402, HBA 404, and PCIe switch 410 to implement firmware instructions such as protocol translation, but the microprocessors themselves are not deemed to be compute elements since they are not used to carry out computations for the services. In this example, multiple TORs are configured in a high availability configuration, and the SSDs and HDDs are dual-port devices for supporting high availability. A single TOR connected to single-port devices can be used in some embodiments.

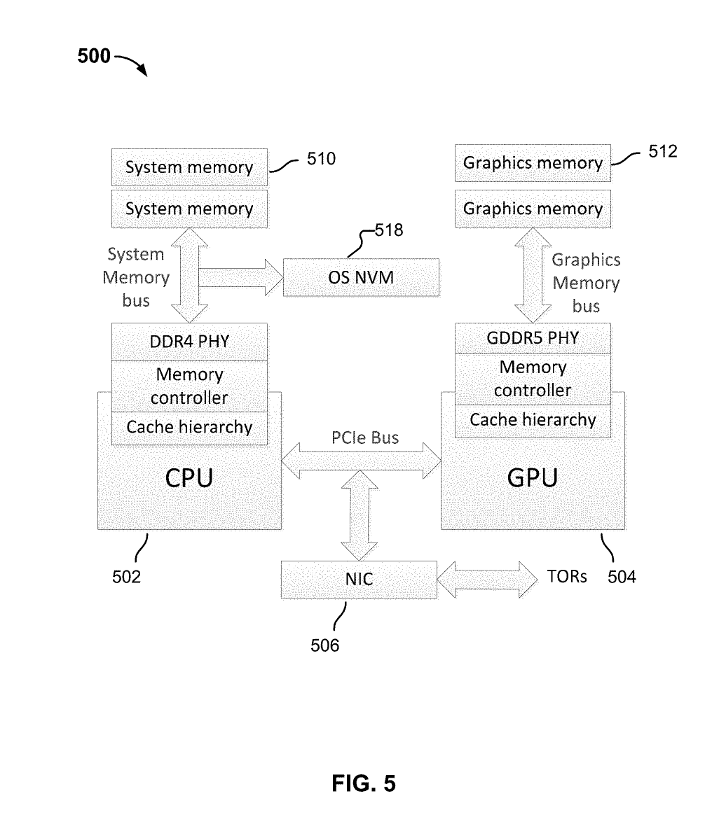

FIG. 5 is a block diagram illustrating embodiments of a compute box.

Compute box 500 includes one or more types of processors to provide computation power. Two types of processors, CPUs 502 and graphical processing units (GPUs) 504 are shown for purposes of example. The processors can be separate chips or circuitries, or a single chip or circuitry including multiple processor cores. Other or different types of processors such as field programmable gate arrays (FPGAs), application specific integrated circuits (ASICs), etc. can also be used.

In this example, PCIe buses are used to connect CPUs 502, GPUs 504, and NIC 506. NIC 506 is installed in a PCIe slot and is connected to one or more TORs. Memories are coupled to the processors to provide the processors with instructions. Specifically, one or more system memories (e.g., high-bandwidth dynamic random access memories (DRAMs)) 510 are connected to one or more CPUs 502 via system memory bus 514, and one or more graphics memories 512 are connected to one or more GPUs 504 via graphics memory buses 516. The use of types of memories/processor combinations allows for fast data processing and transfer for specific purposes. For example, videos and images will be processed and transferred by the GPUs at a higher rate than they would by the CPUs. One or more operating system (OS) non-volatile memory (NVM) 518 store boot code for the operating system. Any standard OS such as Linux, Windows Server, etc., can be used. In this example, the OS NVM is implemented using one or more byte-addressable memories such as NOR flash, which allows for fast boot up of the operating system.

The compute box is configured to perform fast computation and fast data transfer between memories and processors, and does not require any storage elements. NIC 506 connects the processors with storage elements in other storage cabinets via the respective TORs to facilitate read/write operations.

The components in boxes 400 and 500 can be off-the-shelf components or specially designed components.

In some embodiments, a compute box or a storage box is configured with certain optional modes in which an optional subsystem is switched on or an optional configuration is set. For example, compute box 500 optionally includes an advanced cooling system (e.g., a liquid cooling system), which is switched on to dissipate heat during peak time, when the temperature exceeds a threshold, or in anticipation of peak usage. The optional system is switched off after the peak usage time or after the temperature returns to a normal level. As another example, compute cabinet 500 is configured to run at a faster clock rate during peak time or in anticipation of peak usage. In other words, the processors are configured to operate at a higher frequency to deliver more computation cycles to meet the resource needs.

The CMM manages resources by grouping the resources into virtual nodes, and maintains mappings of virtual nodes to resources. Table 1 illustrates an example of a portion of a mapping table. Other data formats can be used. As shown, a virtual node includes storage resources from a storage box, and compute resources from a compute box. As will be discussed in greater detail below, the mapping can be dynamically adjusted.

TABLE 1

| Virtual | | | | | | | | |
|---|---|---|---|---|---|---|---|---|
| Node | Storage | | | Compute | | | | |
| ID | Resources | | | Resources | | | Service | Virtual IP |
| 1 | HDD 420/ | SDD 450/ | . . . | CPU core | CPU core | . . . | Database | 1.2.3.4 |
| | Storage | Storage | | 520/ | 522/ | | Service | |
| | box 400 | box 400 | | Compute | Compute | | | |
| | | | | box 500 | box 500 | | | |
| 2 | SDD 452/ | SDD 454/ | . . . | CPU core | — | . . . | Cache | 5.6.7.8 |
| | Storage | Storage | | 524/ | | | Service | |
| | box 400 | box 400 | | Compute | | | | |
| | | | | box 500 | | | | |
| 3 | HDD 422/ | SDD 456/ | — | CPU core | GPU | . . . | Offline | 9.10.11.12 |
| | Storage | Storage | | 524/ | core 550/ | | Data | |
| | box 400 | box 400 | | Compute | Compute | | Processing | |
| | | | | box 500 | box 500 | | Service | |

The CMM maintains virtual nodes, resources, and services mappings. It also performs capacity management by adjusting the grouping of resources and virtual nodes.

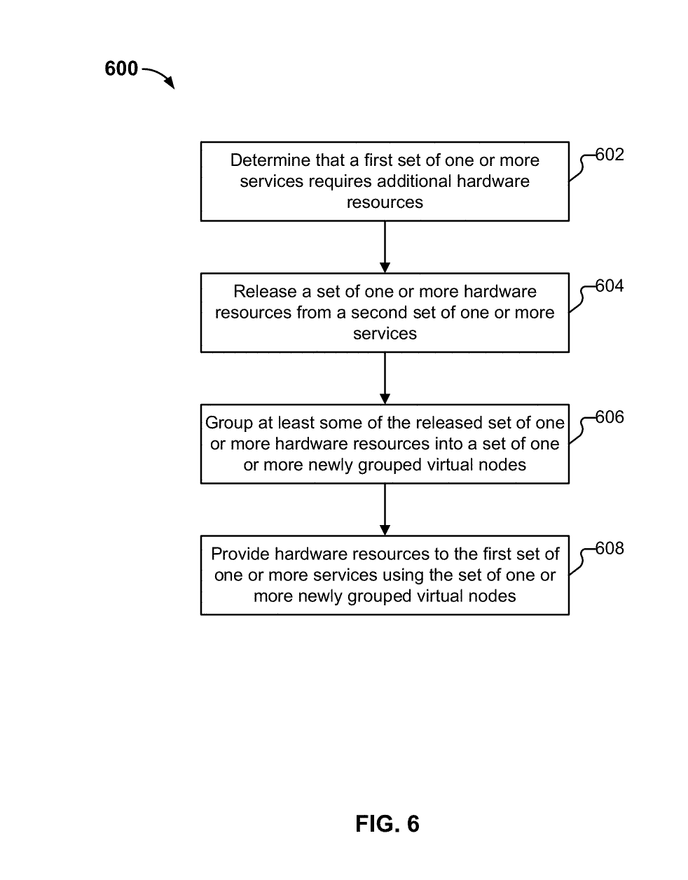

FIG. 6 is a flowchart illustrating an embodiment of a process for performing capacity management. Process 600 can be performed by a CMM.

At 602, it is determined that a first set of one or more services configured to execute on one or more virtual nodes requires one or more additional hardware resources. In this case, the first set of one or more services can include a critical service or a high priority service. For example, the first services can include a database service, a load balancing service, etc.

A variety of techniques can be used to make the determination that the first service requires additional hardware resources. In some embodiments, the determination is made based at least in part on monitoring resources usages. For example, the CMM and/or a monitoring application can track usage and/or send queries to services to obtain usage statistics; the services can automatically report usage statistics to the CMM and/or monitoring application; etc. Other appropriate determination techniques can be used. When the usage of a service exceeds a certain threshold (e.g., a threshold number of storage elements, a threshold number of processors, etc.), it is determined that one or more additional hardware resources are needed. In some embodiments, the determination is made based at least in part on historical data. For example, if a usage peak for the service was previously detected at a specific time, then the service is determined to require additional hardware resources at that time. In some embodiments, the determination is made according to a configuration setting. For example, the configuration setting may indicate that a service will need additional hardware resources at a certain time, or under some specific conditions.

At 604, a set of one or more hardware resources is released from a second set of one or more services, according to the need that was previously determined. Compared with the first service, the second set of one or more services can be lower priority services than the first set of one or more services. For example, the second services can include a CDN service for which a cache miss impacts performance but does not result in a failure, a data processing service for which performance is not time critical, or the like. The specific hardware resources (e.g., a specific CPU or a specific drive) to be released can be selected based on a variety of factors, such as the amount of remaining work to be completed by the resource, the amount of data stored on the resource, etc. In some cases, a random selection is made.

In some embodiments, to release the hardware resources, the CMM sends commands to the second set of services via predefined protocols. The second services respond when they have successfully freed the resources needed by the first set of services. In some embodiments, the CMM is not required to notify the second set of services; rather, the CMM simply stops sending additional storage or computation tasks associated with the second set of services to the corresponding cabinets from which resources are to be released.

At 606, at least some of the released set of one or more hardware resources are grouped into a set of one or more virtual nodes. In some cases, the grouping is based on physical locations. For example, the CMM maintains the physical locations of the resources, and storage and/or compute resources that are located in physical proximity are grouped together in a new virtual node. In some cases, the grouping is based on network conditions. For example, storage and/or compute resources that are located in cabinets with similar network performance (e.g., handling similar bandwidth of traffic) or meet certain network performance requirements (e.g., round trip time that at least meets a threshold) are grouped together in a new virtual node. A newly grouped virtual node can be a newly created node or an existing node to which some of the released resources are added. The mapping information of virtual nodes and resources is updated accordingly.

At 608, hardware resources are provided to the first set of one or more services using the set of newly grouped virtual nodes. A newly grouped virtual node is assigned the virtual IP address that corresponds to a first service. The CMM directs traffic designated to the service to the virtual IP. If multiple virtual nodes are used by the same service, a load balancer will select a virtual node using standard load balancing techniques such as least weight, round robin, random selection, etc. Thus, the hardware resources corresponding to the virtual node are selected to be used by the first service.

Process 600 depicts a process in which resources are borrowed from low priority services and redistributed to high priority services. At a later point in time, it will be determined that the additional hardware resources are no longer needed by the first set of services; for example, the activity level falls below a threshold or the peak period is over. At this point, the resources previously released by the second set of services and incorporated into grouped virtual nodes are released by the first set of services, and returned to the nodes servicing the second set of services. The CMM will update its mapping accordingly.

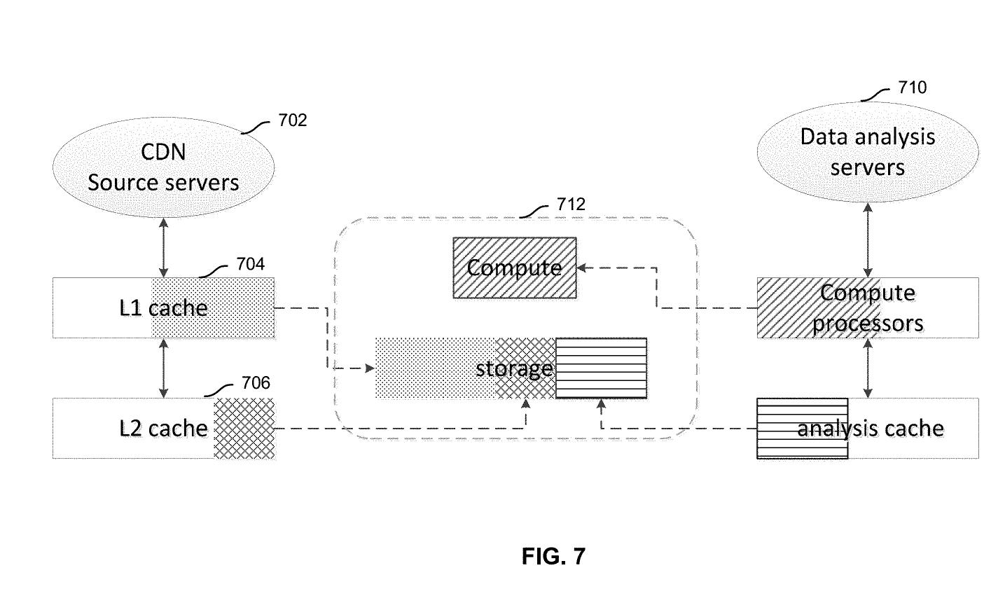

FIG. 7 is a block diagram illustrating the borrowing of resources from low priority services to meet the demands of a high priority service. In this example, a high priority service such as a database service requires additional storage and compute resources. A CDN service stores data on source servers 702, and stores temporary copies of a subset of the data in two levels of caches (L1 cache 704 and L2 cache 706) to reduce data access latency. The caches are implemented using storage elements on one or more storage-based cabinets. The CDN service is a good candidate for lending storage resources to the high priority service since the data in CDN's caches can be discarded without moving any data around. When the CDN service releases certain storage elements used to implement its cache, the cache capacity is reduced and the cache miss rate goes up, which means that more queries to the source servers are made to obtain the requested data.

Further, a data analysis/processing server 710 lends compute resources and storage resources to the high priority service. In this case, the data processing server runs services such as data warehousing, analytics, etc., which are typically performed offline and have a flexible deadline for delivering results, thus making the service a good candidate for lending compute resources to the high priority service. When the data processing service releases certain processors from its pool of processors and certain storage elements from its cache, it will likely take longer to complete the data processing. Since the data processing is done offline, the slowdown is well tolerated.

A virtual node 712 is formed by grouping (combining) the resources borrowed from the CDN service and the offline data processing service. These resources in the virtual node are used to service the high priority service during peak time. After the peak, the virtual node can be decommissioned and its resources returned to the CDN service and the data processing service. By trading off the CDN service's latency and the data processing service's throughput, the performance of the database service is improved. Moreover, the dynamic grouping of the resources on cabinet-scale devices means that the devices do not need to be physically rearranged.

Referring to the example of Table 1, suppose that the database service operating on the virtual IP address of 1.2.3.4 requires additional storage resources and compute resources. Storage resources and compute resources can be released from the cache service operating on the virtual IP address of 5.6.7.8 and from the offline data processing service operating on the virtual IP address of 9.10.11.12. The released resources are combined to form a new virtual node 4. Table 2 illustrates the mapping table after the regrouping.

TABLE 2

| Virtual | | | | | | | | |
|---|---|---|---|---|---|---|---|---|
| Node | Storage | | | Compute | | | | |
| ID | Resources | | | Resources | | | Service | Virtual IP |
| 1 | HDD 420/ | SDD 450/ | . . . | CPU core | CPU core | . . . | Database | 1.2.3.4 |
| | Storage | Storage | | 520/ | 522/ | | Service | |
| | box 400 | box 400 | | Compute | Compute | | | |
| | | | | box 500 | box 500 | | | |
| 2 | — | SDD 454/ | . . . | CPU core | — | . . . | Cache | 5.6.7.8 |
| | | Storage | | 524 / | | | Service | |
| | | box 400 | | Compute | | | | |
| | | | | box 500 | | | | |
| 3 | HDD 422/ | | — | — | GPU | . . . | Offline | 9.10.11.12 |
| | Storage | | | | core 550/ | | Data | |
| | box 400 | | | | Compute | | Processing | |
| | | | | | box 500 | | Service | |
| 4 | SDD 452/ | SDD 456/ | — | CPU core | | | Database | 1.2.3.4 |
| | Storage | Storage | | 524/ | | | Service | |
| | box 400 | box 400 | | Compute | | | | |
| | | | | box 500 | | | | |

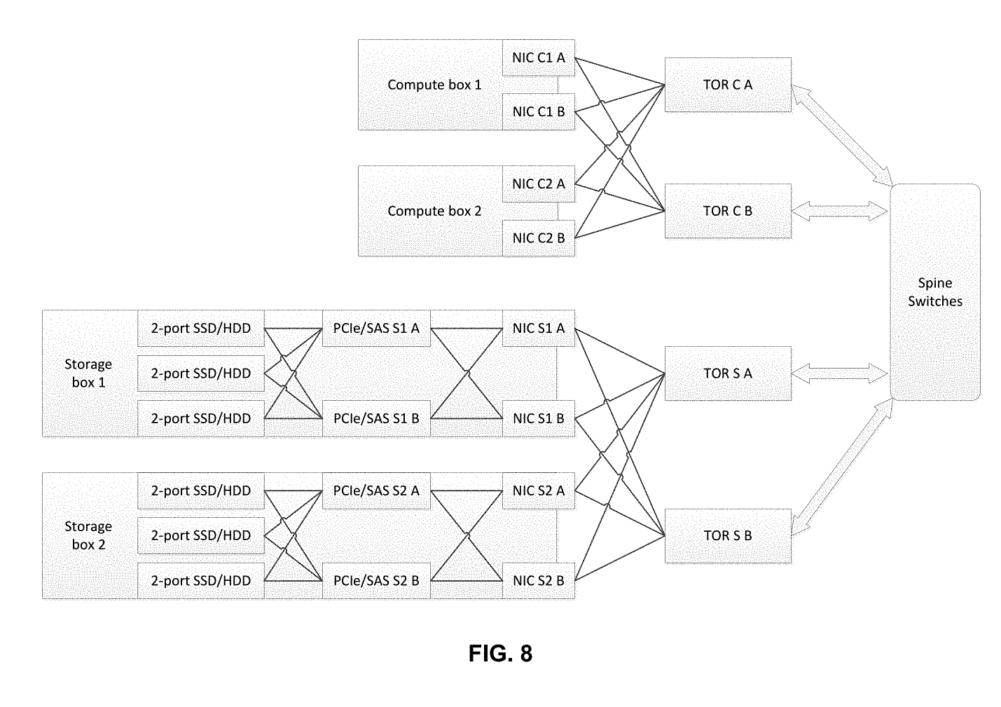

In some embodiments, the system employing cabinet-scale devices is designed to be an HA system. FIG. 8 is a block diagram illustrating an embodiment of a capacity managed system in high availability configuration. In this example, in each cabinet, there are two TORs connected to the spine switches. Each storage box or compute box includes two NICs connected to the pair of TORs. In the event of an active NIC failure or an active TOR failure, the standby NIC or the standby TOR will act as a backup to maintain the availability of the system.

In a storage box, the PCIe switches and the HBA cards are also configured in pairs for backup purposes. The storage elements SSD and HDD are dual port elements, so that each element is controlled by a pair of controllers in an HA configuration (e.g., an active controller and a standby controller). Each storage element can be connected to two hosts. In a compute box, the processors are dual-port processors, and they each connect to backup processors in the same compute box, or in different compute boxes (either within the same cabinet or in different cabinets) via the NICs and the TORs on the storage boxes, the spine switches, and the TORs and NICs on the compute boxes. If one storage element (e.g., a drive) fails, the processor connected to the failed storage element can still fetch, modify, and store data with a backup storage element that is in a different storage box (within the same cabinet as the failed storage element or in a different storage cabinet). If a processor fails, its backup processor can continue to work with the storage element to which the processor is connected. The high availability design establishes dual paths or multiple paths through the whole data flow.

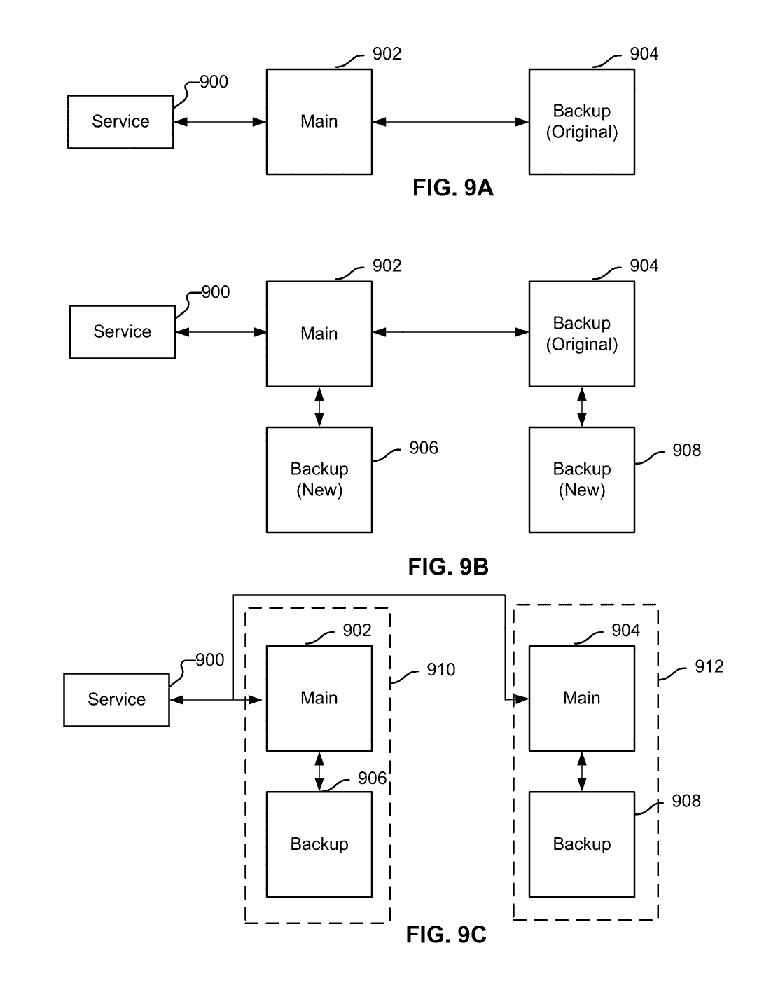

FIG. 9A is a block diagram illustrating an embodiment of a high availability configuration. In this example, a main virtual node 902 is configured to have a corresponding backup virtual node 904. Main virtual node 902 is configured to provide hardware resources to service 900. Backup virtual node 904 is configured to provide redundancy support for main virtual node 902. While main virtual node 902 is operating normally, backup virtual node 904 is in standby mode and does not perform any operations. In the event that main virtual node 902 fails, backup virtual node 904 will take over and provide the same services as the main virtual node to avoid service interruptions.

When the service supported by the main node requires additional hardware resources (e.g., when peak usage is detected or anticipated), process 600 is performed and newly grouped virtual nodes are formed. In this case, providing hardware resources to the service using the newly grouped virtual nodes includes reconfiguring standby pairs.

In FIG. 9B, two new backup virtual nodes 906 and 908 are configured. The new backup virtual nodes are selected from the newly grouped virtual nodes formed using resources released by lower priority services. Virtual node 906 is configured as a new backup virtual node for main virtual node 902, and virtual node 908 is configured as a new backup virtual node for original backup virtual node 904. The new backup virtual nodes are synchronized with their respective virtual nodes 902 and 904 and are verified. The synchronization and verification can be performed according to the high availability protocol.

In FIG. 9C, original backup node 904 is promoted to be a main virtual node. In this example, a management tool such as the CMM makes a role or assignment change to node 904. At this point, node 904 is no longer the backup for main node 902. Rather, node 904 functions as an additional node that provides hardware resources to service 900. Two high availability pairs 910 and 912 are formed. In this case, by borrowing hardware resources from other lower priority services, the system has doubled its capacity for handling high priority service 900 while providing HA capability, without requiring new hardware to be added or physical arrangement of the devices to be altered. When the peak is over, main 904 can be reconfigured to be a backup for 902, and backups 906 and 908 can be decommissioned and their resources returned to the lower priority services from which the resources were borrowed.

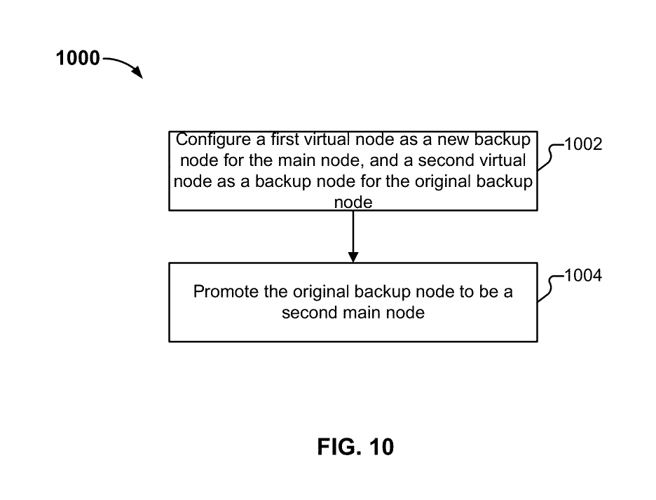

FIG. 10 is a flowchart illustrating an embodiment of a high availability configuration process. Process 1000 can be used to implement the process shown in FIGS. 9A-9C. The process initiates with the states shown in FIG. 9A. At 1002, a first virtual node is configured as a new backup node for the main node, and a second virtual node is configured as a backup node for the original backup node, as shown in FIG. 9B. At 1004, the original backup node is promoted (e.g., reconfigured) to be a second main node, as shown in FIG. 9C.

Capacity management has been disclosed. The technique disclosed herein allows for flexible configuration of infrastructure resources, fulfills peak capacity requirements without requiring additional hardware installations, and provides high availability features. The cost of running data centers can be greatly reduced as a result.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of capacity management, comprising:
determining that a first set of one or more services configured to execute on a set of one or more existing virtual nodes requires additional hardware resources;
releasing a set of one or more hardware resources from a second set of one or more services;
grouping at least some of the released set of one or more hardware resources into a set of one or more newly grouped virtual nodes; and
providing hardware resources to the first set of one or more services using at least the set of one or more newly grouped virtual nodes.

2. The method of claim 1, wherein:
a virtual node among the set of one or more existing virtual nodes includes a plurality of storage resources; and
the plurality of storage resources are included in a cabinet-scale storage system that is provides storage resources but does not provide compute resources.

3. The method of claim 1, wherein:
a virtual node among the set of one or more existing virtual nodes includes a plurality of compute resources; and
the plurality of compute resources are included in a cabinet-scale compute system that provides compute resources but does not provide storage resources.

4. The method of claim 1, wherein the released set of one or more hardware resources includes a storage element, a processor, or both.

5. The method of claim 1, wherein the first set of one or more services has higher priority than the second set of one or more services.

6. The method of claim 1, wherein the first set of one or more services includes one or more of: a database service, a load balance service, a diagnostic service, a high performance computation service, and/or a storage service.

7. The method of claim 1, wherein the second set of one or more services includes one or more of: a content delivery network service, a data processing service, and/or a cache service.

8. The method of claim 1, wherein the providing of hardware resources to the first set of one or more services using at least the set of one or more newly grouped virtual nodes includes assigning a request associated with the first set of one or more services to at least some of the set of one or more newly grouped virtual nodes.

9. The method of claim 1, wherein:
at least one of the set of one or more existing virtual nodes is configured as a main node having an original backup node; and
the providing of hardware resources to the first set of one or more services using at least the set of one or more newly grouped virtual nodes includes:
configuring a first virtual node among the set of one or more newly grouped virtual nodes as a new backup node for the main node, and a second virtual node among the set of one or more newly grouped virtual nodes as a backup node for the original backup node of the main node; and
promoting the original backup node of the main node to be a second main node.

10. A capacity management system, comprising:
one or more processors configured to:
determine that a first set of one or more services configured to execute on a set of one or more existing virtual nodes requires additional hardware resources;
cause a second set of one or more services to release a set of one or more hardware resources;
group at least some of the released set of one or more hardware resources into a set of one or more newly grouped virtual nodes; and
provide hardware resources to the first set of one or more services using at least the set of one or more newly grouped virtual nodes; and
one or more memories coupled to the one or more processors, configured to provide the one or more processors with instructions.

11. The system of claim 10, wherein:
a virtual node among the set of one or more existing virtual nodes includes a plurality of storage resources; and
the plurality of storage resources are included in a cabinet-scale storage system.

12. The system of claim 10, wherein:
a virtual node among the set of one or more existing virtual nodes includes a plurality of storage resources; and
the plurality of storage resources are included in a cabinet-scale storage system; wherein the cabinet-scale storage system includes:
one or more top of rack (TOR) switches; and
a plurality of storage devices coupled to the one or more TORs; wherein the one or more TORs switch storage-related traffic and do not switch compute-related traffic.

13. The system of claim 10, wherein:
a virtual node among the set of one or more existing virtual nodes includes a plurality of compute resources; and
the plurality of compute resources are included in a cabinet-scale compute system.

14. The system of claim 10, wherein:
a virtual node among the set of one or more existing virtual nodes includes a plurality of compute resources;
the plurality of compute resources are included in a cabinet-scale compute system; and
the cabinet-scale compute system includes:
one or more top of rack (TOR) switches; and
a plurality of compute devices coupled to the one or more TORs; wherein the one or more TORs switch compute-related traffic and do not switch storage-related traffic.

15. The system of claim 10, wherein the released set of one or more hardware resources includes a storage element, a processor, or both.

16. The system of claim 10, wherein the first set of one or more services has higher priority than the second set of one or more services.

17. The system of claim 10, wherein the first set of one or more services includes one or more of: a database service, a load balance service, a diagnostic service, a high performance computation service, and/or a storage service.

18. The system of claim 10, wherein the second set of one or more services includes one or more of: a content delivery network service, a data processing service, and/or a cache service.

19. The system of claim 10, wherein to provide hardware resources to the first set of one or more services using at least the set of one or more newly grouped virtual nodes includes to assign a request associated with the first set of one or more services to at least some of the set of one or more newly grouped virtual nodes.

20. The system of claim 10, wherein:
at least one of the set of one or more existing virtual nodes is configured as a main node having an original backup node; and
to provide hardware resources to the first set of one or more services using at least the set of one or more newly grouped virtual nodes includes to:
configure a first virtual node among the set of one or more newly grouped virtual nodes as a new backup node for the main node, and a second virtual node among the set of one or more newly grouped virtual nodes as a backup node for the original backup node of the main node; and
promote the original backup node of the main node to be a second main node.

21. A computer program product for capacity management, the computer program product being embodied in a tangible non-transitory computer readable storage medium and comprising computer instructions for:
determining that a first set of one or more services configured to execute on a set of one or more existing virtual nodes requires additional hardware resources;
releasing a set of hardware resources from a second set of one or more services;
grouping at least some of the released set of one or more hardware resources into a set of one or more newly grouped virtual nodes; and
providing hardware resources to the first set of one or more services using at least the set of one or more newly grouped virtual nodes.
